(19) United States
(12) Patent Application Publication
(10) Pub. No.: US 2021/0295225 A1
(43) Pub. Date: Sep. 23, 2021

(54) LONG-TERM FACILITY MAINTENANCE PLANNING METHOD AND APPARATUS

(71) Applicant: SitelogIQ, Inc., Minneapolis, MN (US)

(72) Inventor: Brian Peters, Roseville, MN (US)

(73) Assignee: SitelogIQ, Inc., Minneapolis, MN (US)

(21) Appl. No.: 16/826,425

(22) Filed: Mar. 23, 2020

(51) Int. Cl. G06Q 10/06; G06Q 10/00

(52) U.S. Cl. CPC G06Q 10/06313; G06Q 10/0633; G06Q 10/20; G06Q 10/06316

(57) ABSTRACT

A method and apparatus for long term facility planning comprising an apparatus having a database, a host server, at least one input/output device, and a network. The host server defines a computer server capable of storing and retrieving large amounts of data. The database includes facility specific information such as facility name, age, location, name age and condition of facility assets, names of projects required to maintain the assets of the facility, financial information relating thereto, priority information thereof, and is adapted to provide on demand a prioritized chronological facility projects list to include balance of project committed costs and a balance of project funding related thereto. The database is further capable of providing various reports filtered by building, asset, or project.

### FIELD OF THE INVENTION

The present invention relates methods and apparatuses for facility planning, and more especially to methods and apparatuses for facility planning that reduce the cost/burden and improve the outcome of facility capital budgeting, and maintenance bidding, and maintenance prioritization.

### BACKGROUND

Public and commercial buildings can have a useful life of 100 years or more. Thus, the maintenance of such facilities can be a long-term endeavor. Most of the assets that comprise such facilities may have to be replaced multiple times over the service life of the facility. Such facility assets may include roofs, windows, doors, casework, flooring, ceilings, mechanical systems, electrical systems, and related technology therefor. In addition to the actual buildings, the grounds or site incident to such buildings also need to be maintained and/or replaced. Such “site assets” may include parking lots, sidewalks, fences, playgrounds, and other similar or equivalent apparatus. However, even if well maintained, all such assets have a finite life. Planning for and implementing the maintenance of such facilities can be a complicated, daunting, and ongoing task.

Many building owners or those responsible for the maintenance thereof typically focus on reactive maintenance tasks and fail to plan for the replacement costs for major assets or major renovations. When assets need replacement or to be upgraded, they are typically budgeted for—such as in a two-year timeframe—using common spreadsheet type software. Such reactive and relatively short-term planning often results in outdated budgets and inadequate maintenance funds which in turns presents challenges in maintaining such facilities.

### SUMMARY

In a first embodiment, the present invention is a preferably computer implemented method and apparatus for providing a Long-Term Facility Maintenance (LTFM) plan. The invention is focused on maintaining a facility/building environment for comfort, low energy and high safety. The apparatus comprises a database, a host server, at least one input device (e.g. a computer, a keyboard or mobile electronic device such as a smart mobile phone) and at least one output device (e.g. a computer, a keyboard or mobile electronic device such as a smart mobile phone or a printer), wherein the database is stored on and accessed from the host server, and wherein the database, the host server, the input devices, and the output devices are connected via a network (i.e. they are networked together). The input devices and the output devices may be integrated into a combined input/output device. The database may be prepared by a third-party provider (Provider), a facility owner or person(s) responsible for the maintenance of the facility (Client), or preferably in a cooperative/collaborative combination thereof. The database is prepared and subsequently maintained as needed (e.g. on a predetermined periodic basis such as an annual basis) by identifying a given facility and inputting, by at least one input device, into the database the facility by name and various facility details such as age, location, function, usage demands, and any other desired information or data. The database is further prepared and subsequently maintained by identifying all of the assets of a given facility and by identifying projects that address the physical needs, educational needs, and functional needs for the facility, and such data is inputted into the database. An asset condition based on age (e.g. in years) and remaining service life (e.g. in years) is assessed and assigned for each asset and inputted into the database. Top priorities are identified by ranking all of the projects with a priority score. The priority score based on the Client prioritization categories is derived and assigned for each need and inputted into the database. The formula for the ‘Priority Score’ can be variable depending upon feedback from the customer. The most significant factor within the priority score for replacement of an asset is the current condition of the asset. The priority categories and the weighting of each variable is determined based on conversations with the client to determine their priorities. Projects will each receive a score in each category as a whole number based on a scale of 1 to 5. Depending on the category, the 5-point ranking scale for prioritization is based on the following assessments: 1 point=Very Low Importance; 2 points=Low Importance; 3 points=Average; 4 points=Important; 5 points=Very Important. Each category score (i.e. the ranking scale value given to a particular category) is then multiplied by a variable shown below in order to determine the ‘Priority Score’ for that project. The example below is a priority ranking applicable to school districts. 7*[Current Condition]+2*[Interconnection with Other Systems]+3*[Educational Impact]+3*[Health, Safety, and Security]+2*[Student and Community Perception]+1*[Return on Investment]+1*[Code Concern]+1*[Prevention of Water Intrusion]. With each project receiving a priority score, we then work with the client to determine a plan for implementation by addressing the higher priorities first. The database is adapted such that based on a plurality of needs, asset conditions, and priority scores, a prioritized project list, preferably in organized (“calendared”) in chronological order (potentially extending out many years—e.g. a ten-year plan), is provided. Each project further includes project details including project budget/cost, system category, funding source, any needed financial code, and project feedback obtained during project implementation. Such project feedback may include for instance a balance of project committed costs and a balance of project funding. The database is further adapted to group or “bundled” needs into “bid packages” for bid acquisition and project implementation. Bid packages are defined by funding source, building, and/or the scope of work required for the bid. As a primary function of the database, the database further provides for a so-called “dashboard” which provides an overview of the project and various standard and customizable reports—including a balance of project committed costs report and a balance of project funding report—and assists in further planning and project review. The reports are preferably interactive, and the database includes the ability to filter projects by selecting different buildings in a given report. The dashboard is preferably provided via POWER BI (see https://en.wikipedia.org/wiki/Power_BI). Clients and others (e.g. Providers) preferably can securely access the database and the reports generated therefrom via a secure remote login, such as via the Microsoft™ Office 365™ platform (see https://en.wikipedia.org/wiki/Office_365).

By defining projects within the database, the invention helps clients manage facility implementation costs. The financial coding of the invention facilitates automation of invoice coding and invoice generation and errors, especially errors otherwise attributable to the payment of invoices from a wrong funding source. Using the invention and managing project costs in the database helps clients to focus on the “balance of committed costs” as opposed to the more traditional “balance of the account” only. Using the invention also helps avoid a situation where a client overspends their annual budget because the client can see that funds still existed in their budget but cannot appreciate outstanding incurred expenses for which the corresponding invoices have not been submitted. Using the invention also helps reduce the challenge of having a fiscal year end during project implementation (e.g. fiscal year ends in June, but the project ends in November). Compared to prior art methods which rely on limited and fallible human memory and individuals being co-located, the present invention, greatly improves the efficiency of long-term facility planning and the computer architecture upon which it relies. The synergistic use of the methods and hardware disclosed herein results in gains in efficiency in long-term facility planning and maintenance not otherwise obtainable by the singular use of any portion thereof.

### BRIEF DESCRIPTION OF DRAWINGS

In order that the advantages of the invention will be readily understood, a more particular description of the invention briefly described above will be rendered by reference to specific embodiments that are illustrated in the appended drawing. Understanding that the drawing depicts only a typical embodiment of the invention and is not therefore to be considered to be limiting of its scope, the invention will be described and explained with additional specificity and detail through the use of the accompanying drawings, in which:

FIG. 1 shows a schematic view of an embodiment of the present invention;

FIG. 2 shows an exemplary “cover page” screen of an embodiment of the present invention and depicts a number of buildings, total area, average building age, total number of projects and a total budget;

FIG. 3 shows an exemplary summary of projects in the database screen of an embodiment of the present invention;

FIG. 4 shows an exemplary summary of schools in a project screen of an embodiment of the present invention;

FIG. 5 shows an exemplary detail of a school of a project screen of an embodiment of the present invention;

FIG. 6 shows an exemplary list of projects screen of an embodiment of the present invention;

FIG. 7 shows an exemplary detail of a project screen of an embodiment of the present invention;

FIG. 8 shows an exemplary summary of bid packages report screen of an embodiment of the present invention;

FIG. 9 shows an exemplary detail of a project of a bid package screen of an embodiment of the present invention;

FIG. 10 shows an exemplary report screen of an embodiment of the present invention having a base building information including building area, building age, building location and an analysis of the building area per student in a school district;

FIG. 11 shows an exemplary summary of a 10-year plan screen of an embodiment of the present invention having 586 projects which total to more than $130,000,000, with the projects summarized by school, facility system, and location, and;

FIG. 12 shows an analysis for a school district screen of an embodiment of the present invention which depicts project funding allocation based upon the Client prioritization.

### DETAILED DESCRIPTION OF EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature table is provided below. It is noted that like features are like numbered throughout all of the figures.

FEATURE TABLE

| # | Feature | # | Feature |
|---|---|---|---|
| 10 | LTFM planning apparatus | 20 | Database |
| 30 | Host server | 40 | Input/output device |
| 50 | Network | | |

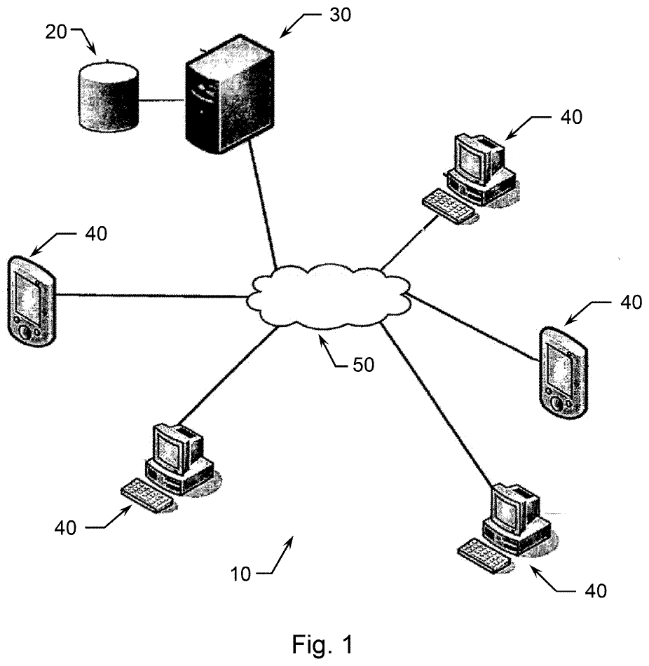

Referring now to FIG. 1, in a preferred embodiment the invention is an LTFM planning method and apparatus 10 comprising database 20, host server 30, at least one (and preferably a plurality of) input/output device 40 and network 50. Host server 30 defines a convention host computer capable of storing and retrieving large amounts of data. Input/output device 40 defines an electro-mechanical apparatus capable of inputting data such as inputting data digitally to a host server and capable of outputting data such as outputting data digitally from a host server. In the preferred embodiment, the input/output device 40 takes the form of a conventional computer such as a keyboard, a desktop or laptop computer or alternatively a mobile electronic device such as a smart phone or a smart tablet. Network 50 defines a computer network, including a wireless or at least partially wireless computer network wherein input/output device 40 is able to communicate with host server 30 so as to access database 20.

Database 20 further defines a database having logical instructions programmed therein so as to cause the database 20 to perform predetermined functions in response to predetermined inputs. Database 20 further includes various LTFM specific information included therein. Database 20 is further prepared by the following steps. A facility is identified by name inputted into database 20, by at least one input device 40, along with various facility details including age, location, function, usage demands and any other desired information or data. Assets of the facility are identified by name and inputted into database 20 by at least one input device 40. A condition to include asset age and remaining asset service life is assessed for each asset and inputted into database 20 by at least one input device 40. Projects that address the physical needs, educational needs, and functional needs of the facility are inputted into database 20 by at least one input device 40. A priority score based on Client prioritization categories is derived and assigned for each project and inputted into the database by at least one input device 40. The formula for the ‘Priority Score’ can be variable depending upon feedback from the customer. In our analysis and research, we have determined that the most significant factor within the priority score for replacement of an asset is the current condition of the asset. The priority categories and the weighting of each variable is determined based on conversations with the client to determine their priorities. Projects will each receive a score in each category as a whole number based on a scale of 1 to 5. Depending on the category, the 5-point ranking scale for prioritization is based on the following assessments: 1 point=Very Low Importance; 2 points=Low Importance; 3 points=Average; 4 points=Important; 5 points=Very Important. Each category score (i.e. the ranking scale value given to a particular category) is then multiplied by a variable shown below in order to determine the ‘Priority Score’ for that project. The example below is a priority ranking applicable to a school district. 7*[Current Condition]+2*[Interconnection with Other Systems]+3*[Educational Impact]+3*[Health, Safety, and Security]+2*[Student and Community Perception]+1*[Return on Investment]+1*[Code Concern]+1*[Prevention of Water Intrusion]. Therefore, the priority score is a weighted score base on twenty points, where the current condition has a 35 percent weighting (i.e. 7/20) in the priority score; the Interconnection with Other Systems has a 10 percent weighting (i.e. 2/20) in the priority score; the Educational Impact has a 15 percent weighting (i.e. 3/20) in the priority score; the Health, Safety, and Security has a 15 percent weighting (i.e. 3/20) in the priority score; the Student and Community Perception has a 10 percent weighting (i.e. 2/20) in the priority score; the Return on Investment has a 5 percent weighting (i.e. 1/20) in the priority score; the Code Concern has a 5 percent weighting (i.e. 1/20) in the priority score; and the Prevention of Water Intrusion has a 5 percent weighting (i.e. 1/20) in the priority score. With each project receiving a priority score, we then work with the client to determine a plan for implementation by addressing the higher priorities first. Project details including project budget/cost, system category, funding source, and any needed financial code are identified and inputted into database 20 by at least one input device 40. It shall be noted that database 20 is further adapted to receive project feedback obtained during project implementation. Such project feedback may include a balance of project committed costs and a balance of project funding.

In practice upon entering a predetermined query into database 20 by means of input/output device 40, apparatus 10 provides a prioritized project list, in a chronologically organized order. The prioritized project list may extend to or cover a long term such as a ten-year plan or any other desired length of time including a time period of one hundred years. Further in practice, upon demand entered into database 20 by means of input/output device 40, apparatus 10 provides bid packages wherein the bid packages are “bundled” for convenient bid acquisition and project implementation. Such bid packages are defined by funding source, building, and/or the scope of work required for the bid. Further in practice, upon demand entered into database 20 by means of input/output device 40, apparatus 10 provides a “dashboard” which provides an overview of the project and various standard and customizable reports—including a balance of project committed costs report and a balance of project funding report. Apparatus 10 is adapted such that the reports are interactive and such that database 20 includes the ability to filter projects by selecting different buildings in a given report. Apparatus 10 is adapted such that secure remote access to database 20 is available via a secure remote login.

A detailed example is provided below showing how the above explained devices operate and communicate with one another in the above disclosed method of providing a Long-Term Facility Maintenance (LTFM) plan. The below example is just one example of the above disclosed method of providing a Long-Term Facility Maintenance (LTFM) plan and other similar or equivalent devices, software, algorithms and hardware may be used in order to accomplish Applicant's disclosed method of providing a Long-Term Facility Maintenance (LTFM) plan.

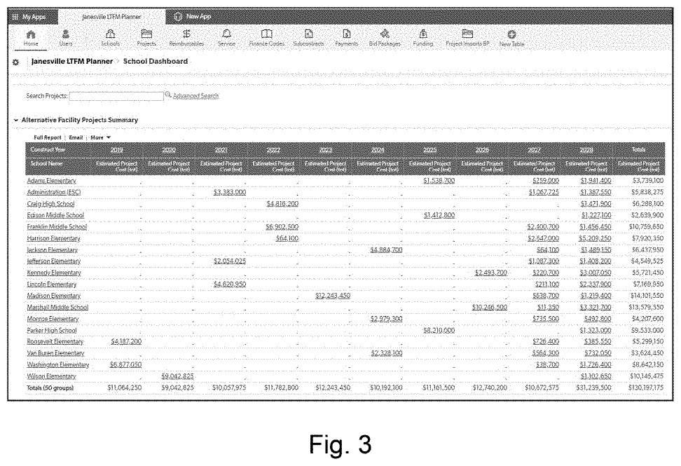

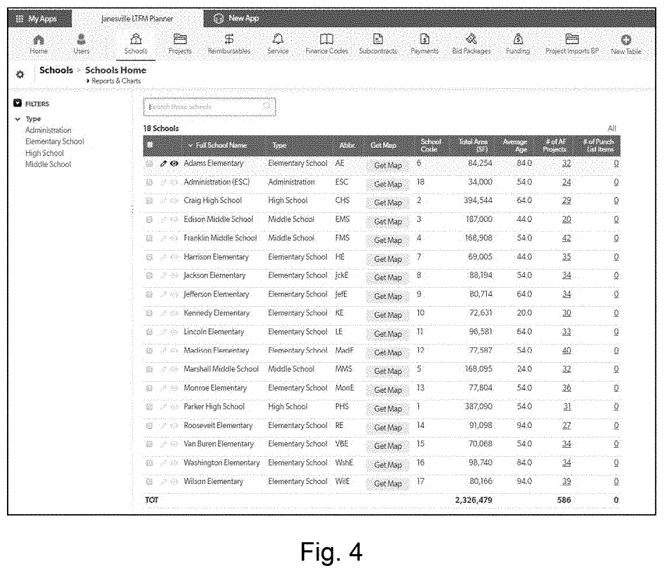

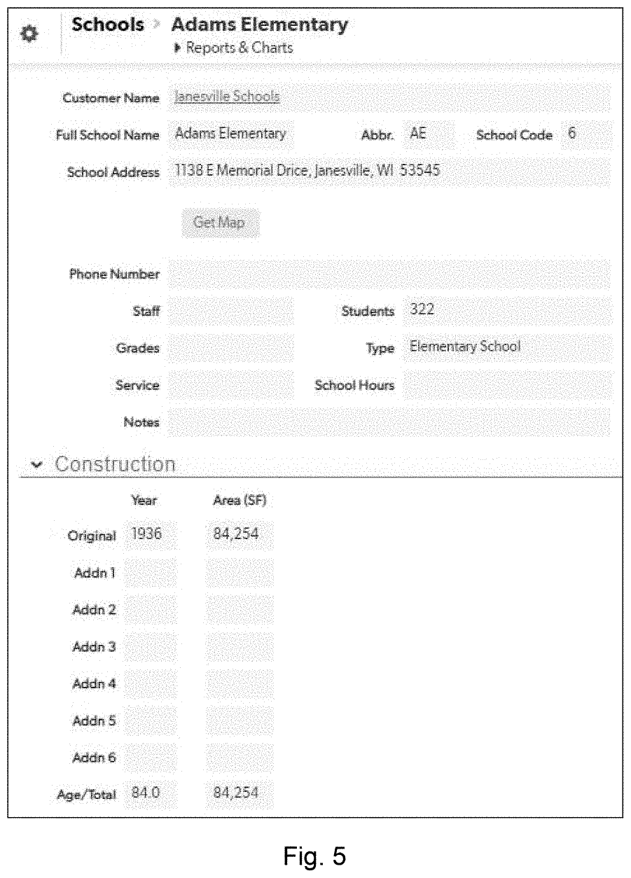

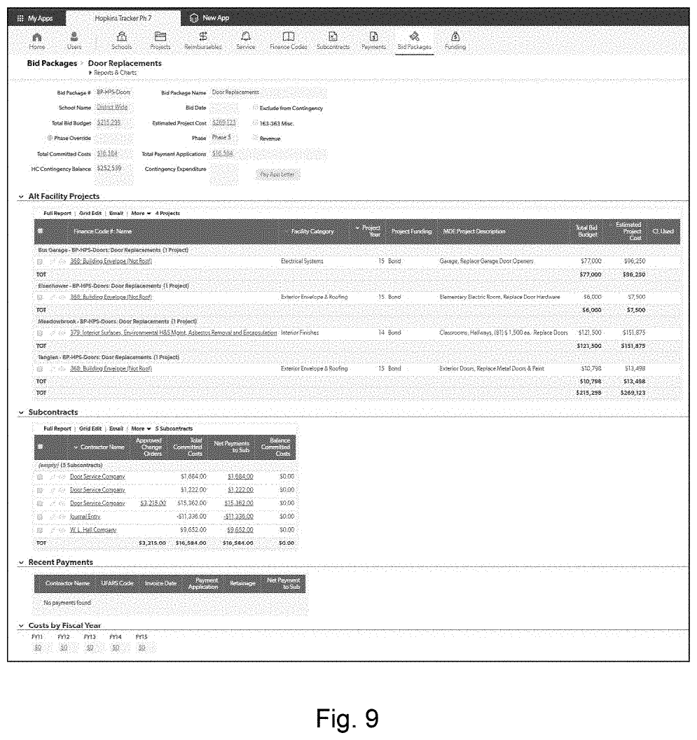

A user uploads/inputs the desired/raw data (e.g. the above disclosed various facility details including name, age, location, function and usage demands) into database 20 using at least one input device 40. Database 20 is pre-loaded with software application(s), algorithm(s) and/or products such as POWER BI, Structured Query Language (SQL), Microsoft™ Office 365™ or any equivalent software or product which can be used to produce output data, charts, figures and graphs; organize, calculate, manipulate and sort data as well as to be able to write additional code and algorithm(s) therein to organize, calculate, manipulate and sort data. After the desired/raw data is uploaded/inputted to database 20, using input/output device 40 such as a mobile electronic device, the user can utilize the above software application(s) (e.g. POWER BI, Structured Query Language (SQL), Microsoft™ Office 365™) to retrieve/withdraw and access the desired data from database 20 and output the retrieved/withdrawn data by using the software application such as Long-Term Facility Maintenance (LTFM) plan and/or by using the software application(s) (e.g. POWER BI, Structured Query Language (SQL), Microsoft™ Office 365™) as shown in FIG. 3. The retrieved/withdrawn desired data can be organized, calculated, manipulated and sorted by using the software application Long-Term Facility Maintenance (LTFM) plan and/or by using the software application(s) (e.g. POWER BI, Structured Query Language (SQL), Microsoft™ Office 365™) which is shown for example in FIG. 4. Within the application, such as the Long-Term Facility Maintenance (LTFM) plan, and/or by using the software application(s) (e.g. POWER BI, Structured Query Language (SQL), Microsoft™ Office 365™), the user can further organize, calculate, manipulate and sort the desired data such as shown in FIG. 5. Additionally, the application, such as the Long-Term Facility Maintenance (LTFM) plan and/or by using the software application(s) (e.g. POWER BI, Structured Queasy Language (SQL), Microsoft™ Office 365™), can create a so-called “dashboard” as shown in FIGS. 9-12 which produces output data, charts, figures and graphs such as an overview of the project and various standard and customizable reports—including a balance of project committed costs report and a balance of project funding report—and assists in further planning and project review.

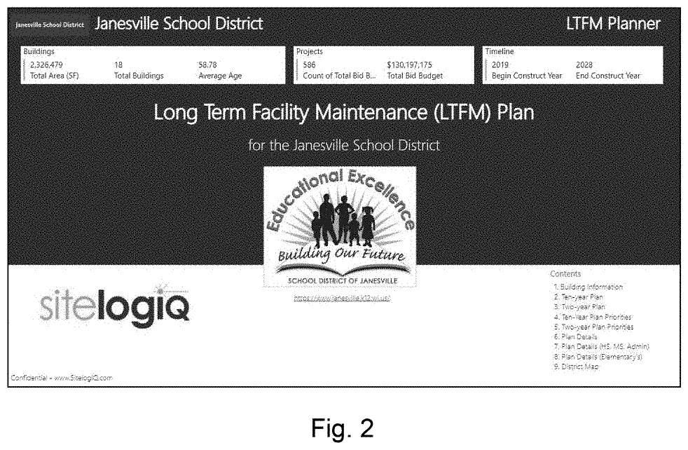

Referring now to the drawings, FIG. 2 represents an exemplary “cover page” screen of an embodiment of the present invention and depicts a number of buildings, total area, average building age, total number of projects and a total budget. FIG. 2 represents an exemplary initial post-login screen—in this instance specific to the Janesville School District—that a user would encounter when using a particular embodiment of the invention.

Referring now to the drawings, FIG. 3 represents an exemplary summary of projects in the database screen of the embodiment of FIG. 2. FIG. 3 represents an exemplary layout of a listing of various schools and projects and costs associated therewith—in this instance specific to the Janesville School District.

Referring now to the drawings, FIG. 4 represents an exemplary screen listing of schools of embodiment of FIG. 2. FIG. 4 includes the school names, abbreviations, map link, code, area in square feet, age, and number of active projects for each school—in this instance specific to the Janesville School District.

Referring now to the drawings, FIG. 5 represents an exemplary detail of a school of a project screen of the embodiment of FIG. 2. FIG. 5 includes school details such as school name, abbreviation, map link, address, code, number of students, school type, age, and area in square feet—in this instance specific to the Janesville School District.

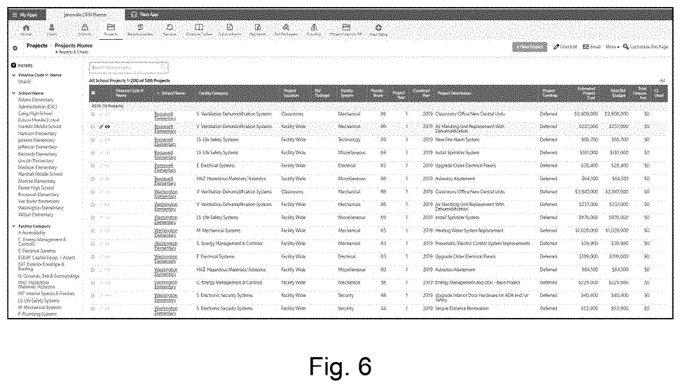

Referring now to the drawings, FIG. 6 represents an exemplary list of projects screen of the embodiment of FIG. 2. FIG. 6 includes for each project: school name, facility category, project location, bid package, facility system, priority score, project year, project description, project funding, estimated project cost, total bid budget, and total fees—in this instance specific to the Janesville School District.

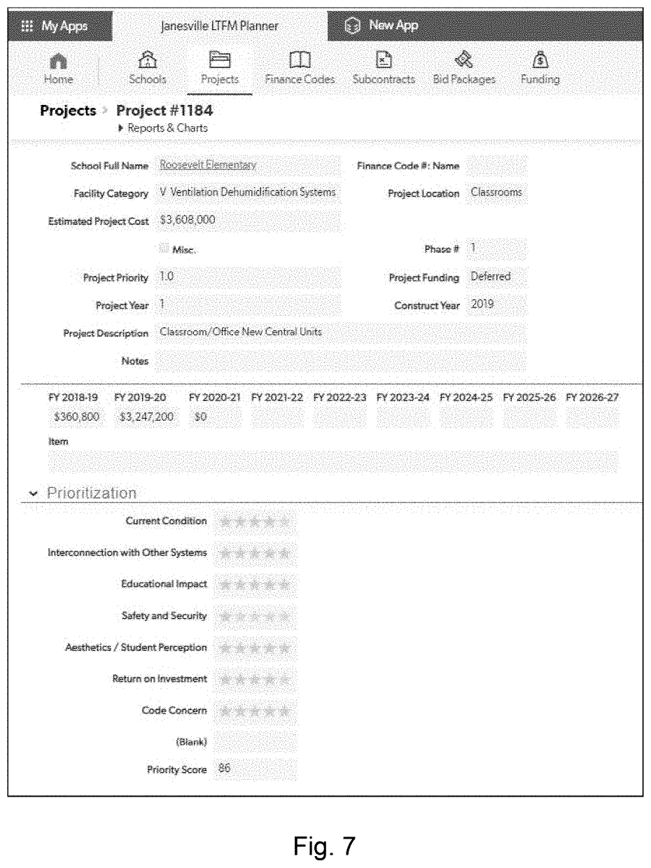

Referring now to the drawings, FIG. 7 represents an exemplary detail of a project screen of the embodiment of FIG. 2. FIG. 7 includes for the project: school name, finance code, facility category, project location, estimated cost, phase, project priority, project funding, project year, construction year, project description, notes, funding of various years, and prioritization categories of current condition, interconnection with other systems, education impact, safety and security, aesthetics and student perception, return on investment, code concern, and a priority score—in this instance specific to Roosevelt Elementary of the Janesville School District.

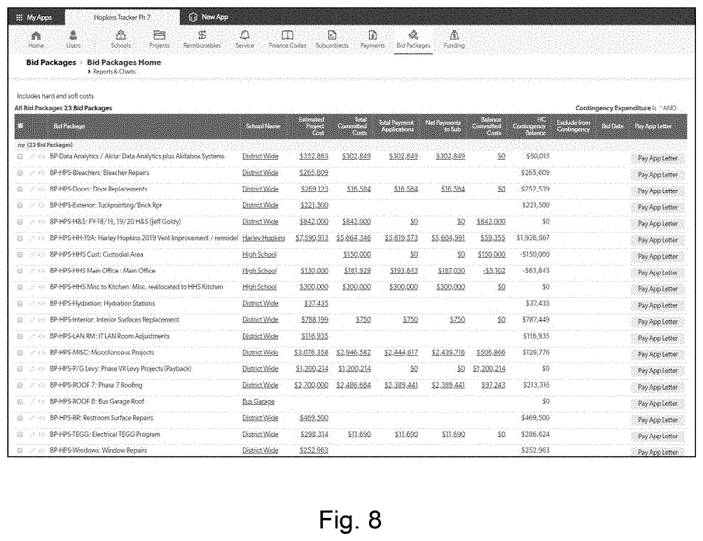

Referring now to the drawings, FIG. 8 represents an exemplary summary of bid packages report screen of the embodiment of FIG. 2. FIG. 8 includes for each bid package: school name, estimate project cost, total committed costs, total payment applications, net payment to sub, balance of committed costs, HC contingency balance, exclusions from contingency, bid date, and pay application letter, —in this instance specific to the Janesville School District.

Referring now to the drawings, FIG. 9 represents an exemplary detail of a project of a bid package screen of the embodiment of FIG. 2. FIG. 9 includes for the bid package: bid package number, bid package name, school name, bid date, exclusions from contingency, total bid budget, estimated project cost, phase override, phase, revenue, total committed costs, total payment applications, HC contingency balance, contingency expenditure, and pay application letter, and detailed listings of projects—in this instance specific to the Janesville School District.

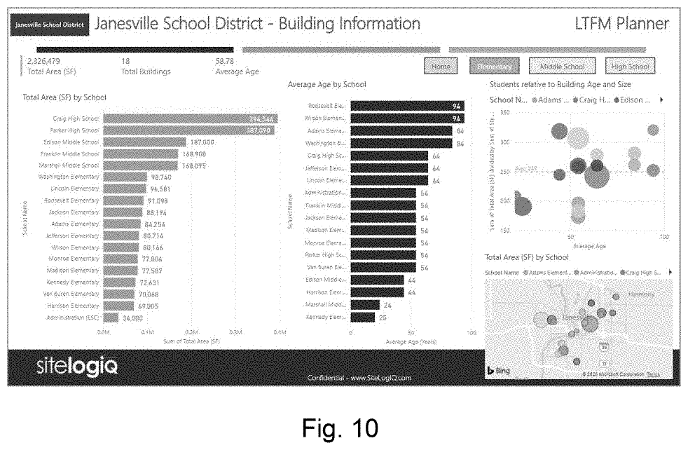

Referring now to the drawings, FIG. 10 represents an exemplary report screen of the embodiment of FIG. 2. FIG. 10 includes for the report: base building information including building area, building age, building location and an analysis of the building area per student in a school district—in this instance specific to the Janesville School District.

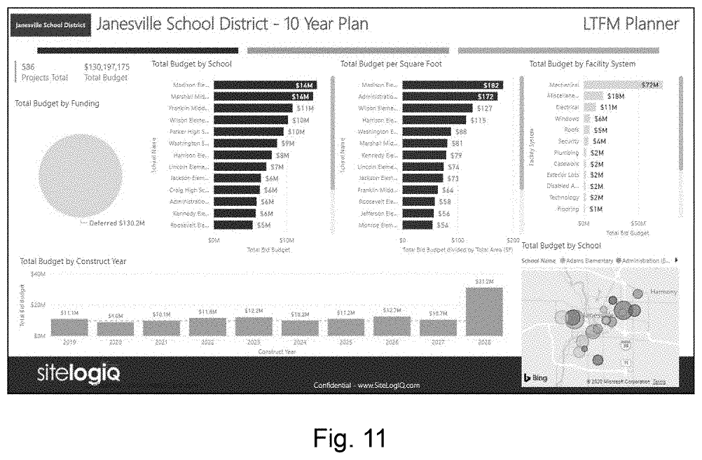

Referring now to the drawings, FIG. 11 represents an exemplary summary of a 10-year plan screen of the embodiment of FIG. 2. FIG. 11 includes for the 10-year plan: 586 projects which total to more than $130,000,000, with the projects summarized by school, facility system, and location—in this instance specific to the Janesville School District.

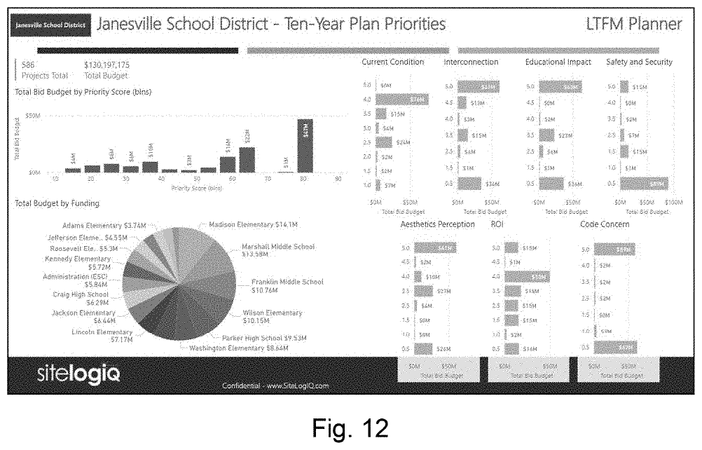

Referring now to the drawings, FIG. 12 represents an exemplary analysis for a school district screen of the embodiment of FIG. 2. FIG. 12 includes for the analysis: project funding allocation based upon the client prioritization—in this instance specific to the Janesville School District.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A facility planning apparatus comprising a database, a host server, a network, and at least one device of an input/output device and an input device and an output device, wherein the database, the host server, and the at least one device are communicably connected by the network, and wherein in response to a predetermined input, the apparatus provides a facility planning report.

2. The facility planning apparatus of claim 1, wherein the database includes facility specific information comprising facility age, facility location, facility function and facility usage demands.

3. The facility planning apparatus of claim 1, wherein the report further comprises a prioritized list of maintenance projects in chronological order of project start date.

4. The facility planning apparatus of claim 3, wherein the prioritized list of maintenance projects is prioritized according to a predetermined project specific user assigned priority score.

5. The facility planning apparatus of claim 4, wherein the database includes project specific information comprising project costs, project budget, project funding source, a project financial code, and a project category.

6. The facility planning apparatus of claim 1, wherein the report further comprises a prioritized list of maintenance projects, each project including at least one of a balance of project committed costs and a balance of project funding.

7. The facility planning apparatus of claim 1, wherein the report further comprises at least one of a two-year minimum facility planning report, a three-year minimum facility planning report, a four-year minimum facility planning report, a five-year minimum facility planning report, an eight-year minimum facility planning report, and a ten-year minimum facility planning report.

8. The facility planning apparatus of claim 1, wherein the report further comprises a list of maintenance projects, each project thereof being associated with at least one asset, and each asset thereof having an asset condition related thereto.

9. The facility planning apparatus of claim 8, wherein the asset condition comprises age of the asset and an assessed remaining service life of the asset.

10. The facility planning apparatus of claim 8, wherein the asset comprises at least one of a building, a roof, a window, a door, a casework, a flooring, a ceiling, a mechanical system, an electrical system, a parking lot, a sidewalk, a fence, a playground and related technology therefor.

11. The facility planning apparatus of claim 9, wherein the remaining service life of the asset is periodically reassessed.

12. The facility planning apparatus of claim 1, wherein the database comprises an identity of at least one facility, the at least one facility specific information comprising facility age, facility location, facility function and facility usage demands, an identity of at least one asset of the at least one facility comprising at least one of a building, a roof, a window, a door, a casework, a flooring, a ceiling, a mechanical system, an electrical system, a parking lot, a sidewalk, a fence, a playground and related technology therefor, an at least one asset condition comprising the at least one asset age and the at least one asset remaining service life, an identity of at least one project of the at least one facility, wherein the at least one project is responsive to at least one of facility physical needs, facility educational needs, and facility functional needs and comprises project details including project budget, project cost, project category, project funding source, and project financial code, and a project priority score for each project thereof.

13. The facility planning database of claim 12, wherein the database is hosted on POWER BI.

14. The facility planning database of claim 12, wherein the database is accessible via a Microsoft™ Office 365™ secure remote login.

15. A facility planning database for use in long term facility maintenance planning, wherein the database comprises an identity of at least one facility, the at least one facility specific information comprising facility age, facility location, facility function and facility usage demands, an identity of at least one asset of the at least one facility comprising at least one of a building, a roof, a window, a door, a casework, a flooring, a ceiling, a mechanical system, an electrical system, a parking lot, a sidewalk, a fence, a playground and related technology therefor, an at least one asset condition comprising the at least one asset age and the at least one asset remaining service life, an identity of at least one project of the at least one facility, wherein the at least one project is responsive to at least one of facility physical needs, facility educational needs, and facility functional needs and comprises project details including project budget, project cost, project category, project funding source, and project financial code, and a project priority score for each project thereof.

16. The facility planning database of claim 15, wherein the database is hosted on POWER BI.

17. The facility planning database of claim 15, wherein the database is accessible via a Microsoft™ Office 365™ secure remote login.

18. A method of using a facility planning apparatus comprising
providing facility planning apparatus comprising a database, a host server, a network, and at least one device of an input/output device and an input device and an output device, wherein the database, the host server, and the at least one device are communicably connected by the network, and wherein in response to a predetermined input, the apparatus provides a facility planning report,
wherein the database comprises an identity of at least one facility, the at least one facility specific information comprising facility age, facility location, facility function and facility usage demands, an identity of at least one asset of the at least one facility comprising at least one of a building, a roof, a window, a door, a casework, a flooring, a ceiling, a mechanical system, an electrical system, a parking lot, a sidewalk, a fence, a playground and related technology therefor, an at least one asset condition comprising the at least one asset age and the at least one asset remaining service life, an identity of at least one project of the at least one facility, wherein the at least one project is responsive to at least one of facility physical needs, facility educational needs, and facility functional needs and comprises project details including project budget, project cost, project category, project funding source, and project financial code, and a project priority score for each project thereof,
inputting a report request into the database, and
receiving a facility planning report in response to the report request.

19. The method of claim 18, wherein the report further comprises a prioritized list of maintenance projects in chronological order of project start date, and includes at least one of a balance of project committed costs and a balance of project funding.

20. The method of claim 18, wherein the report further comprises at least one of a two-year minimum facility planning report, a three-year minimum facility planning report, a four-year minimum facility planning report, a five-year minimum facility planning report, an eight-year minimum facility planning report, and a ten-year minimum facility planning report, and wherein the remaining service life of the asset is periodically reassessed.
